(19) United States
(12) Patent Application Publication
(10) Pub. No.: US 2024/0049290 A1
(43) Pub. Date: Feb. 8, 2024

(54) SIGNALING TO INDICATE INTENDED SLICE INFORMATION IN PAGING

(71) Applicant: QUALCOMM Incorporated, San Diego, CA (US)

(72) Inventors: Peng CHENG, Beijing (CN); Jianhua LIU, Beijing (CN); Ravi AGARWAL, San Diego, CA (US); Miguel GRIOT, La Jolla, CA (US); Hong CHENG, Basking Ridge, NJ (US); Ozcan OZTURK, San Diego, CA (US); Gavin Bernard HORN, La Jolla, CA (US)

(21) Appl. No.: 18/257,246

(22) PCT Filed: Feb. 2, 2021
(86) PCT No.: PCT/CN2021/074845

§ 371 Date: Jun. 13, 2023

(51) Int. Cl. H04W 74/08; H04W 76/20; H04W 68/02; H04W 48/18; H04W 36/08

(52) U.S. Cl. CPC H04W 74/0833; H04W 76/20; H04W 68/02; H04W 48/18; H04W 36/08

(57) ABSTRACT

Various aspects of the present disclosure generally relate to wireless communication. In some aspects, a user equipment (UE) may receive, in a radio resource control (RRC) idle mode or an RRC inactive mode, a paging message that includes an indication identifying an intended slice for a protocol data unit (PDU) session associated with downlink traffic for the UE. The UE may transmit, to a base station, a request to initiate a random access channel (RACH) procedure based at least in part on the intended slice. Numerous other aspects are described.

### FIELD OF THE DISCLOSURE

Aspects of the present disclosure generally relate to wireless communication and to techniques and apparatuses for signaling to indicate intended slice information in paging.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a UE includes receiving, in a radio resource control (RRC) idle mode or an RRC inactive mode, a paging message that includes an indication identifying an intended slice for a protocol data unit (PDU) session associated with downlink traffic for the UE; and transmitting, to a base station, a request to initiate a random access channel (RACH) procedure based at least in part on the intended slice.

In some aspects, a method of wireless communication performed by a base station includes transmitting, to a UE in an RRC idle mode or an RRC inactive mode, a paging message that includes an indication identifying an intended slice for a PDU session associated with downlink traffic for the UE; and receiving, from the UE, a request to initiate a RACH procedure based at least in part on the intended slice.

In some aspects, a UE for wireless communication includes a memory and one or more processors operatively coupled to the memory, the memory and the one or more processors configured to: receive, in an RRC idle mode or an RRC inactive mode, a paging message that includes an indication identifying an intended slice for a PDU session associated with downlink traffic for the UE; and transmit, to a base station, a request to initiate a RACH procedure based at least in part on the intended slice.

In some aspects, a base station for wireless communication includes a memory and one or more processors operatively coupled to the memory, the memory and the one or more processors configured to: transmit, to a UE in an RRC idle mode or an RRC inactive mode, a paging message that includes an indication identifying an intended slice for a PDU session associated with downlink traffic for the UE; and receive, from the UE, a request to initiate a RACH procedure based at least in part on the intended slice.

In some aspects, a non-transitory computer-readable medium storing a set of instructions for wireless communication includes one or more instructions that, when executed by one or more processors of a UE, cause the UE to: receive, in an RRC idle mode or an RRC inactive mode, a paging message that includes an indication identifying an intended slice for a PDU session associated with downlink traffic for the UE; and transmit, to a base station, a request to initiate a RACH procedure based at least in part on the intended slice.

In some aspects, a non-transitory computer-readable medium storing a set of instructions for wireless communication includes one or more instructions that, when executed by one or more processors of a base station, cause the base station to: transmit, to a UE in an RRC idle mode or an RRC inactive mode, a paging message that includes an indication identifying an intended slice for a PDU session associated with downlink traffic for the UE; and receive, from the UE, a request to initiate a RACH procedure based at least in part on the intended slice.

In some aspects, an apparatus for wireless communication includes means for receiving, in an RRC idle mode or an RRC inactive mode, a paging message that includes an indication identifying an intended slice for a PDU session associated with downlink traffic for the apparatus; and means for transmitting, to a base station, a request to initiate a RACH procedure based at least in part on the intended slice.

In some aspects, an apparatus for wireless communication includes means for transmitting, to a UE in an RRC idle mode or an RRC inactive mode, a paging message that includes an indication identifying an intended slice for a PDU session associated with downlink traffic for the UE; and means for receiving, from the UE, a request to initiate a RACH procedure based at least in part on the intended slice.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of network slice assignment for a UE, in accordance with the present disclosure.

FIG. 4 is a diagram illustrating an example associated with signaling to indicate intended slice information in paging, in accordance with the present disclosure.

FIGS. 5-6 are diagrams illustrating example processes associated with signaling to indicate intended slice information in paging, in accordance with the present disclosure.

FIGS. 7-8 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

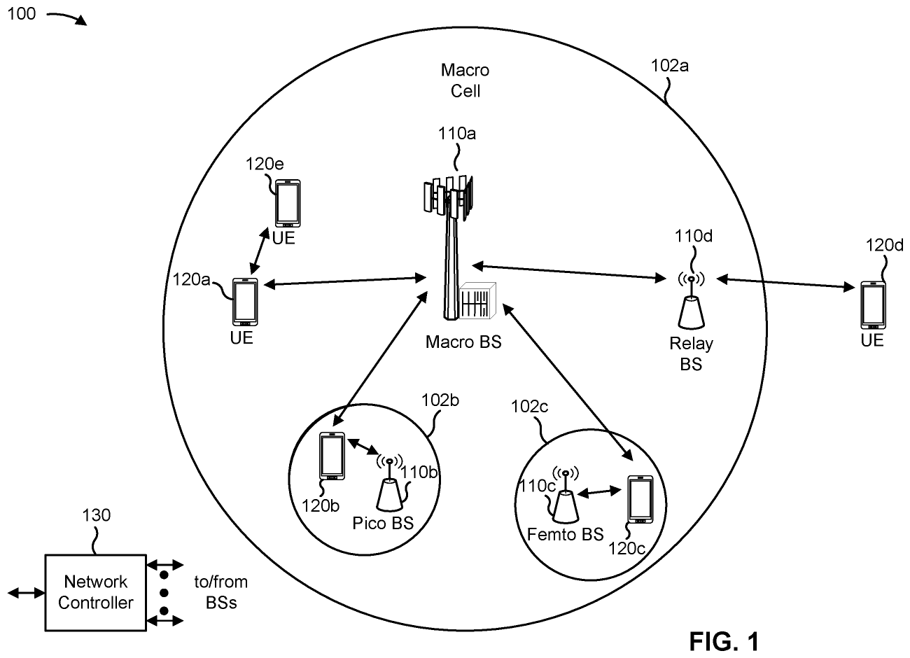

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

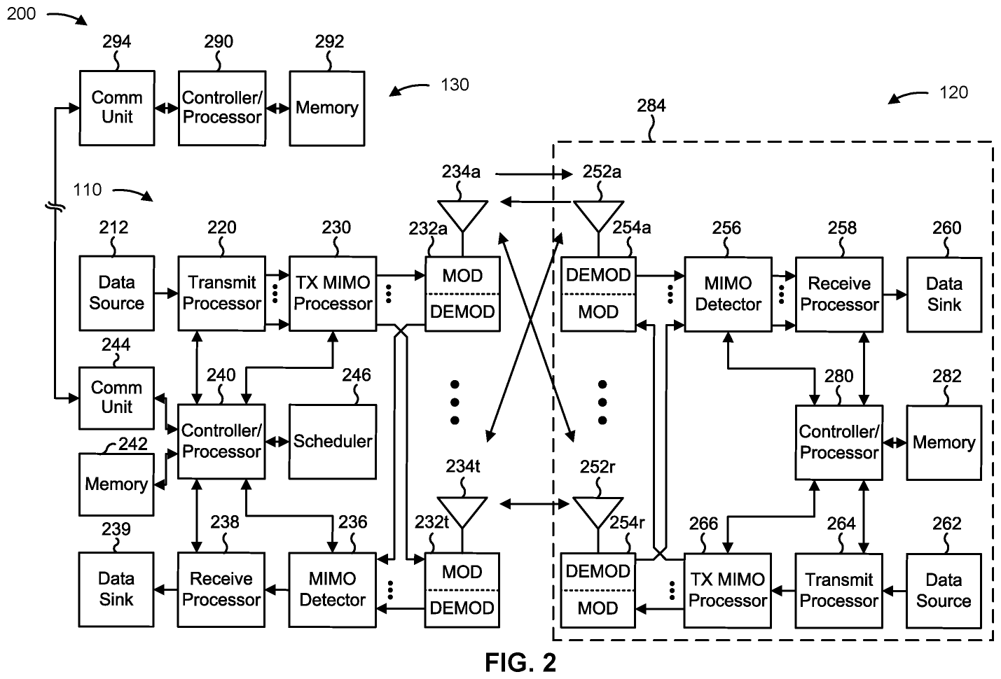

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

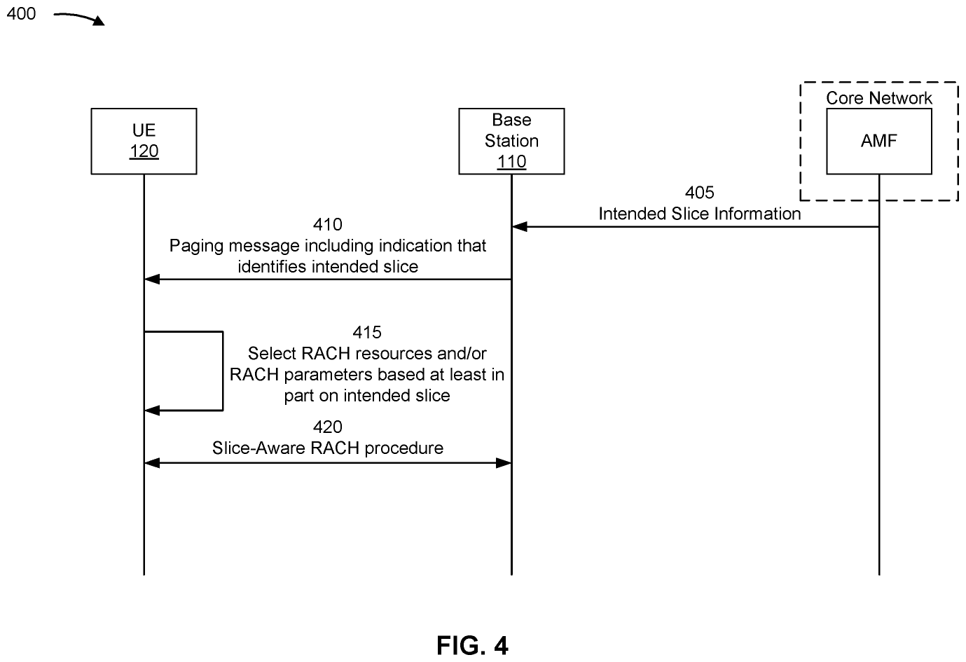

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-6.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-6.

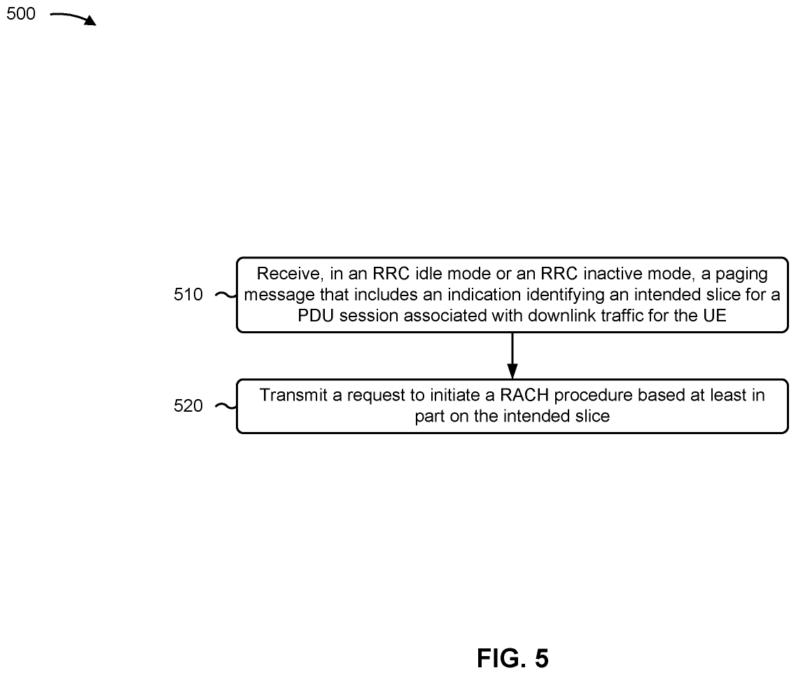

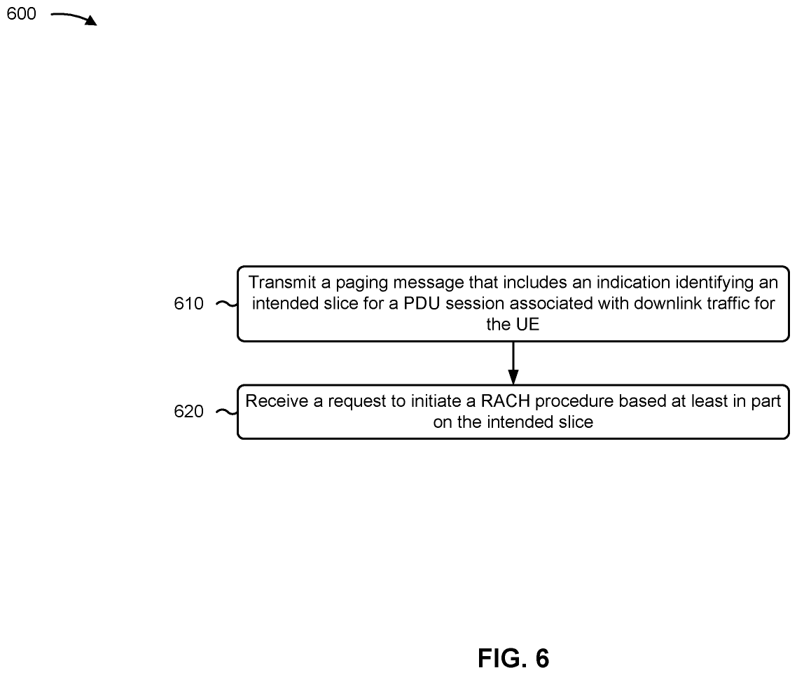

Controller/processor 240 of base station 110, controller/processor 280 of UE 120, and/or any other component(s) of FIG. 2 may perform one or more techniques associated with signaling to indicate intended slice information in paging, as described in more detail elsewhere herein. For example, controller/processor 240 of base station 110, controller/processor 280 of UE 120, and/or any other component(s) of FIG. 2 may perform or direct operations of, for example, process 500 of FIG. 5, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some aspects, executing instructions may include running the instructions, converting the instructions, compiling the instructions, and/or interpreting the instructions, among other examples.

In some aspects, the UE 120 includes means for receiving, in a radio resource control (RRC) idle mode or an RRC inactive mode, a paging message that includes an indication identifying an intended slice for a protocol data unit (PDU) session associated with downlink traffic for the UE; and/or means for transmitting, to a base station, a request to initiate a random access channel (RACH) procedure based at least in part on the intended slice. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE 120 includes means for receiving, prior to receiving the paging message, a configuration of a respective slice group index, for each of one or more allowed slices for the UE.

In some aspects, the UE 120 includes means for selecting, for the RACH procedure, one or more RACH resources associated with an urgent slice.

In some aspects, the UE 120 includes means for selecting, for the RACH procedure, one or more RACH parameters associated with an urgent slice.

In some aspects, the UE 120 includes means for determining single-network slice selection assistance information (S-NSSAI) for the intended slice based at least in part on the PDU session identifier.

In some aspects, the UE 120 includes means for determining the intended slice from the cause value based at least in part on a mapping between network slice selection assistance information (NSSAI) and cause values.

In some aspects, the UE 120 includes means for receiving the mapping in a system information block (SIB).

In some aspects, the UE 120 includes means for discarding the mapping; and/or means for receiving a new mapping in an SIB of the new cell.

In some aspects, the UE 120 includes means for receiving the mapping in a non-access stratum (NAS) message.

In some aspects, the UE 120 includes means for receiving the mapping in an RRC release message.

In some aspects, the UE 120 includes means for selecting, for the RACH procedure, at least one of a RACH resource associated with the intended slice or a RACH parameter associated with the intended slice.

In some aspects, the UE 120 includes means for selecting, for the RACH procedure, one or more RACH resources from a RACH resource pool configured for the intended slice.

In some aspects, the UE 120 includes means for selecting, for the RACH procedure, one or more RACH resources from a RACH resource pool configured for a slice group associated with the intended slice.

In some aspects, the UE 120 includes means for selecting, for the RACH procedure, one or more RACH parameters associated with a prioritization level configured for the intended slice.

In some aspects, the UE 120 includes means for selecting, for the RACH procedure, one or more RACH parameters associated with a prioritization level configured for a slice group associated with the intended slice.

In some aspects, the base station 110 includes means for transmitting, to a UE in an RRC idle mode or an RRC inactive mode, a paging message that includes an indication identifying an intended slice for a PDU session associated with downlink traffic for the UE; and/or means for receiving, from the UE, a request to initiate a RACH procedure based at least in part on the intended slice. The means for the base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for determining the radio bearer identifier for the logical channel associated with the intended slice based at least in part on N3 tunnel information for the downlink traffic.

In some aspects, the base station 110 includes means for determining the cause value that maps to the intended slice based at least in part on a mapping between NSSAI and cause values.

In some aspects, the base station 110 includes means for transmitting the mapping to the UE in an SIB.

In some aspects, the base station 110 includes means for transmitting the mapping to the UE in an RRC release message.

In some aspects, the base station 110 includes means for receiving, from the UE, the request to initiate the RACH procedure using one or more RACH resources associated with the intended slice.

In some aspects, the base station 110 includes means for receiving, from the UE, the request to initiate the RACH procedure using one or more RACH parameters associated with the intended slice.

In some aspects, the base station 110 includes means for receiving, from a core network device, slice information associated with the intended slice.

In some aspects, the base station 110 includes means for receiving, from the core network device, an N2 paging request that includes the slice information associated with the intended slice.

In some aspects, the base station 110 includes means for transmitting, to one or more other base stations in a radio access network (RAN) based notification area associated with the UE, a RAN paging message that includes the slice information associated with the intended slice.

In some aspects, the base station 110 includes means for receiving, from another base station in a RAN based notification area associated with the UE, a RAN paging message that includes slice information associated with the intended slice.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

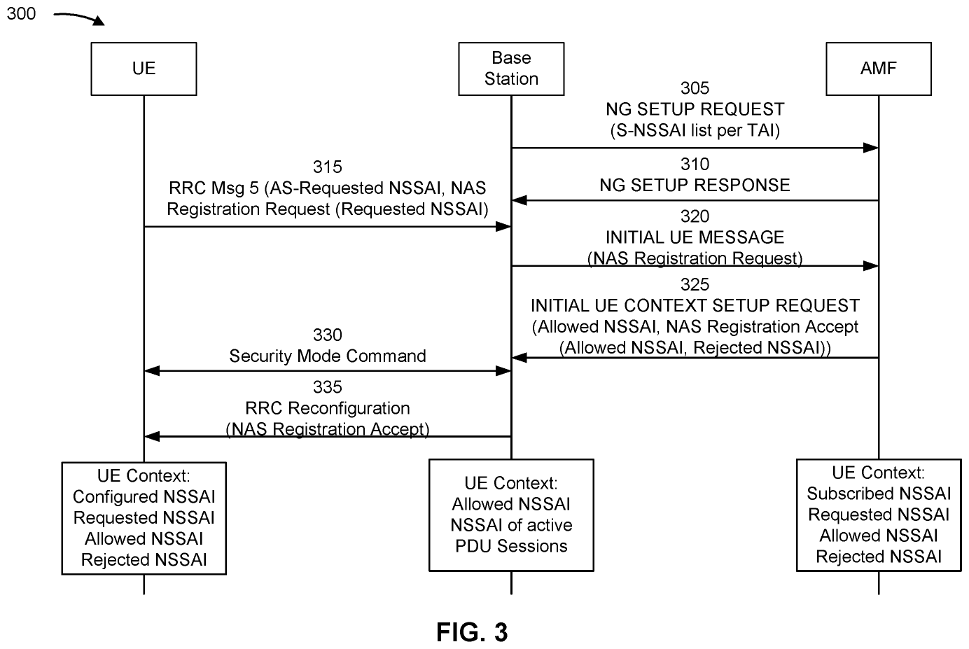

FIG. 3 is a diagram illustrating an example 300 of network slice assignment for a UE, in accordance with the present disclosure.

Network slicing involves implementing logical networks on top of a shared physical infrastructure, where each network slice may include an end-to-end connection of functions deployed for a particular application, application type, traffic type, or use case, among other examples. Each network slice may be identified by a network slice identity. A network slice identity may include a slice identifier referred to as a single-network slice selection assistance information (S-NSSAI). An S-NSSAI may indicate a slice service type (SST) using an SST value. For example, the SST value may indicate a network slicing type associated with enhanced mobile broadband (eMMB) communications, ultra-reliable low-latency communications (uRLLC), IoT communications, or V2X communications.

As shown in FIG. 3, network slices for a UE may be negotiated in an NAS registration procedure. As shown by reference number 305, during a 5G next generation (NG) setup procedure, a base station (e.g., gNB) may transmit, to an access and mobility management function (AMF) of a core network (e.g., 5G core network), an NG setup request message. The base station may include, in the NG setup request message, a list of S-NSSAIs supported by the base station. The list of S-NSSAIs may include supported S-NSSAIs per tracking area identity (TAI). As shown by reference number 310, the AMF may transmit, to the base station, an NG setup response message. In some examples, the NG setup response message may include a list of S-NSSAIs supported by the AMF. For example, the list of S-NSSAIs supported by the AMF may include S-NSSAIs associated with network slicing instances in a public land mobile network (PLMN).

As further shown in FIG. 3, and by reference number 315, the UE may transmit, to the base station in an RRC Msg5 message, an NAS registration request message including requested NSSAI. For example, the UE may transmit the RRC Msg5 message to the base station during a procedure to establish a PDU session. The requested NSSAI may include an S-NSSAI or a list of multiple S-NSSAIs. In some examples, the UE may select the requesting NSSAI from configured NSSAI for the UE. The UE may also include, in the RRC Msg5 message, access stratum (AS)-requested NSSAI. The AS-requested NSSAI may be used by the base station to perform AMF select from multiple AMF instances in the core network. In some examples, the AS-requested NSSAI may be a subset of the requested NSSAI in the NAS registration request (for example, due to security concerns with the RRC Msg5 message).

As shown by reference number 320, the base station may transmit, to the AMF in the core network, an initial UE message that includes the NAS registration request message received from the UE. The AMF may determine allowed NSSAI for the UE from the requested NSSAI. For example, the AMF may validate the requested NSSAI based on subscribed NSSAI. The subscribed NSSAI may be a list of S-NSSAIs to which the UE is subscribed, and the AMF may compare each S-NSSAI in the requested NSSAI with the subscribed NSSAI to determine whether the UE is subscribed to that S-NSSAI. The AMF may determine whether the S-NSSAI(s) in the requested NSSAI are in the list of supported S-NSSAIs for the TAI in which the UE is located. The allowed NSSAI may include one or more S-NSSAIs in the requested NSSAI that are included in the subscribed NSSAI and in the list of supported S-NSSAIs supported for the TAI. In some examples, the allowed NSSAI may include default S-NSSAI(s) if no valid S-NSSAIs are requested. Rejected NSSAI includes S-NSSAI(s) in the rested NSSAI that are not included in the allowed NSSAI. As shown by reference number 325, the AMF may transmit, to the base station in an initial UE context setup request message, an NAS registration accept message that indicates the allowed NSSAI and the rejected NSSAI. The AMF may also include the allowed NSSAI in the initial UE context setup request message.

As shown in FIG. 3, and by reference number 330, the base station may transmit a security mode command message to the UE. The security mode command message is used to command the UE to activate AS security. As shown in reference number 335, the base station may transmit, to the UE in an RRC reconfiguration message, the NAS registration accept message that includes the accepted NSSAI and the rejected NSSAI. The PDU session established for the UE may be associated with a slice (e.g., identified by an S-NSSAI) in the allowed NSSAI. The UE may store UE context information including the configured NSSAI, the requested NSSAI, the allowed NSSAI, and the rejected NSSAI. The base station may store UE context information including the allowed NSSAI for the UE and NSSAI of active PDU sessions. The AMF may store UE context information including the subscribed NSSAI, the requested NSSAI, the allowed NSSAI, and the rejected NSSAI.

As indicated above, FIG. 3 is provided as an example. Other examples may differ from what is described with respect to FIG. 3.

In a case in which a UE is in an RRC idle mode or an RRC inactive mode, arriving traffic (e.g., uplink traffic or downlink traffic) may trigger the UE to perform a RACH procedure to establish a PDU session. For mobile-originated (MO) traffic (e.g., uplink traffic) originating from the UE, the UE may be aware of an intended slice for the PDU session. For example, the NAS of the UE may indicate an allowed S-NSSAI for the PDU session. In this case, the UE may perform a slice-aware RACH procedure. For example, the UE may select RACH resources from an isolated RACH resource pool associated with the intended slice and/or use RACH parameters associated with a prioritization level of the intended slice. However, for mobile-terminated (MT) traffic (e.g., downlink traffic) terminating at the UE, the UE may not be aware of an intended slice for the PDU session. Accordingly, the UE may not perform a slice-aware RACH procedure. Thus, the UE may not be able to use isolated RACH resources or RACH parameters associated with the intended slice. This may result in increased latency for the RACH procedure and decreased prioritization based on an application, application type, traffic type, or use case associated with MT traffic, as compared with MO traffic.

Some techniques and apparatuses described herein enable a UE to receive, in an RRC idle mode or an RRC inactive mode, a paging message that includes an indication identifying an intended slice for a PDU session associated with downlink (e.g., MT) traffic for the UE. A base station may transmit, to the UE, the paging message including the indication identifying the intended slice. The UE may transmit, to the base station, a request to initiate a slice-aware RACH procedure based at least in part on the intended slice. As a result, the latency of the RACH procedure for the UE may be reduced and the RACH procedure may be prioritized based on an application, application type, traffic type, or use case associated with the intended slice.

FIG. 4 is a diagram illustrating an example 400 associated with signaling to indicate intended slice information in paging, in accordance with the present disclosure. As shown in FIG. 4, example 400 includes communication between a base station 110, a UE 120, and an AMF of a core network. In some aspects, the base station 110 and the UE 120 may be included in a wireless network, such as wireless network 100. The base station 110 and the UE 120 may communicate via a wireless access link, which may include an uplink and a downlink. In some aspects, the AMF may include, or may be included on, one or more core network devices, such as network controller 130, in the core network. In some aspects, the core network may be a 5G core network or an LTE evolved packet core (EPC) network.

As shown in FIG. 4, and by reference number 405, the AMF may transmit intended slice information to the base station 110. The intended slice information may be slice information (e.g., S-NSSAI) that identifies an intended slice associated with MT traffic (e.g., downlink traffic) for the UE. The intended slice is a network slice that is to be used for a PDU session to deliver the MT traffic to the UE. In some aspects, the AMF may receive the intended slice information for the PDU session from a session management function (SMF) in the core network.

In some aspects, the AMF may transmit the intended slice information to the base station 110 in an N2 paging request message. N2 is the control plane interface between an NG-RAN (e.g., base station 110) and the 5G core network. In some aspects, such as in a case in which the UE 120 is in an RRC idle mode, the AMF may transmit the N2 paging request message including the intended slice information to all base stations in a tracking area associated with the UE 120. For example, the AMF may transmit the N2 paging request message including the intended slice information to the base station 110 and to one or more other base stations in the tracking area associated with the UE 120.

In some aspects, such as in a case in which the UE 120 is in an RRC inactive mode and the base station 110 is an anchor base station associated with the UE 120, the base station 110 may transmit a RAN paging message that includes the intended slice information to one or more other base stations in a RAN based notification area (RNA) associated with the UE 120. In some aspects, such as in a case in which the UE 120 is in the RRC inactive mode and the base station 110 is not the anchor base station associated with the UE 120, the base station 110 may receive the intended slice information in a RAN paging message from the anchor base station associated with the UE 120.

As further shown in FIG. 4, and by reference number 410, the base station 110 may transmit, to the UE 120, a paging message that includes an indication that identifies the intended slice for a PDU session associated with MT traffic (e.g., downlink traffic) for the UE 120. The base station 110 may transmit the paging message to the UE 120, while the UE 120 is in the RRC idle mode or the RRC inactive mode, to alert the UE 120 of an incoming connection request associated with the MT traffic for the UE 120. For example, the paging message may be a physical downlink shared channel (PDSCH) paging message transmitted to the UE 120 in a paging occasion of a discontinuous reception (DRX) cycle associated with the UE 120. The paging message may include a paging record for the UE 120, and the base station 110 may include the indication that identifies the intended slice in the paging record for the UE 120.

In some aspects, the indication may include an SST value associated with the intended slice. For example, the indication may include the SST value from the S-NSSAI associated with the intended slice. In this case, the base station 110 may include the SST value in the paging record for the UE 120.

In some aspects, the indication may include a slice group index associated with the intended slice. The base station 110 may include the slice group index in the paging record for the UE 120. In this case, the AMF may store the slice group index for the intended slice for the PDU session. The UE 120 may be configured (e.g., prior to entering the RRC idle mode or the RRC inactive mode) with a slice group for each of a plurality of slices (e.g., each slice in configured NSSAI or allowed NSSAI for the UE 120). For example, the slice groups may be configured for the UE 120 via an NAS message or via subscription information associated with NSSAI to which the UE 120 is subscribed.

In some aspects, the indication may include an urgent slice indication in the paging record for the UE 120. For example, the urgent slice indication may be an indication in a particular field of the paging record. In this case, UE 120 may be configured with an urgent slice (e.g., in the allowed NSSAI for the UE 120) that corresponds to the urgent slice indication. The UE 120 may select, for a RACH procedure, one or more RACH resources from a prioritized pool of RACH resources associated with the urgent slice and/or one or more RACH parameters associated with the urgent slice (e.g., RACH parameters associated with a high prioritization level).

In some aspects, the indication may include a PDU session identifier (ID) associated with the PDU session. The base station 110 may include the PDU session ID in the paging record for the UE 120. In this case, the UE 120 may derive the intended slice information from the PDU session ID. For example, the UE 120 may determine the S-NSSAI for the intended slice based at least in part on the PDU session ID.

In some aspects, the indication may include a radio bearer ID for a logical channel associated with the intended slice. The base station 110 may include the radio bearer ID in the paging record for the UE 120. The base station 110 may determine the radio bearer ID for the logical channel associated with the intended slice based at least in part on N3 tunnel information for the MT traffic. N3 is an interface between a RAN (e.g., base station 110) and a user plane function (UPF) in the 5G core network. The UE 120 may determine the intended slice based at least in part on the radio bearer ID.

In some aspects, the base station 110 may map the intended slice information to a cause value in the paging record for the UE 120. The cause value is a value in a paging cause field of the paging record. The base station 110 may map the intended slice information to a particular cause value based at least in part on a mapping between slice information (e.g., NSSAI) for multiple network slices and a respective cause value associated with each slice. The UE 120 may be configured with the mapping (e.g., prior to entering the RRC idle mode or the RRC connected mode), and may determine the intended slice from the cause value in the paging record for the UE 120 based at least in part on the mapping.

In some aspects, the UE 120 may receive the mapping configuration in an SIB transmitted by the base station 110. In this case, after performing cell reselection (e.g., switching to a new cell), the UE 120 may discard the stored mapping configuration and acquire a new mapping configuration in a SIB of the new cell. In some aspects, the UE 120 may receive the mapping configuration in an NAS message from a core network device (e.g., from the AMF). In some aspects, the UE 120 may receive the mapping configuration in an RRC release message transmitted by the base station 110. In some aspects, the mapping may be configured in the UE 120 via subscription information associated with network slices to which the UE 120 is subscribed. In some aspects, the UE 120 may receive a dynamic indication of the mapping configuration (e.g., via an NAS message or via an RRC release message), and the dynamic indication may override a previous mapping configuration (e.g., configured via an SIB or configured via subscription information).

In some aspects, the intended slice information for the UE 120 may be the same within the same tracking area (e.g., for different base stations within the same tracking area) and may be updated during a tracking area update (TAU) procedure (e.g., for the UE 120 in the RRC idle mode) or a RAN area update (RNAU) procedure. In this case, the mapping between the slice information and the cause values may be updated during the TAU procedure and/or the RNAU procedure, and the UE 120 may receive the updated mapping configuration (e.g., via an NAS message).

In some aspects, the AMF or the SMF may map the intended slice information to the cause value, and the AMF may transmit the cause value to the base station 110. In this case, the base station 110 may receive the cause value from the AMF, include the cause value in the paging field of the paging record for the UE 120, and transmit, to the UE 120, the paging message including the paging record for the UE 120.

As further shown in FIG. 4, and by reference number 415, the UE 120 may select RACH resources and/or RACH parameters based at least in part on the intended slice. The UE 120 may determine the intended slice for the PDU session based at least in part on the indication in the paging message, and the UE 120 may select RACH resources and/or RACH parameters for a RACH procedure based at least in part on the intended slice.

In some aspects, the UE 120 may identify a slice-specific RACH resource pool configured for the intended slice. For example, the slice-specific RACH resource pool may include separate or isolated resources from a common RACH resource pool. The UE 120 may select one or more RACH resources for a RACH procedure from the slice-specific resource pool. In some aspects, the UE 120 may identify a RACH resource pool configured for a slice group associated with the intended slice. The UE 120 may select one or more RACH resources for the RACH procedure from the RACH resource pool configured for the slice group associated with the intended slice. As a result, the UE 120 may avoid collisions in the common RACH resource pool when performing the RACH procedure.

In some aspects, the UE 120 may select, for the RACH procedure, one or more RACH parameters configured for the intended slice. For example, the UE 120 may select one or more RACH parameters associated with a prioritization level configured for the intended slice. In some aspects, the UE 120 may select, for the RACH procedure, one or more RACH parameters configured for a slice group associated with the intended slice. For example, the UE 120 may select one or more RACH parameters associated with a prioritization level configured for a slice group associated with the intended slice. In some aspects, the prioritization level configured for the slice or for the slice group may correspond to a prioritization level associated with a particular application, application type, traffic type, or use case, among other examples. For example, the prioritization level may correspond to a prioritization level associated with eMMB communications, uRLLC, IoT communications, or V2X communications, among other examples.

As further shown in FIG. 4, and by reference number 420, the UE 120 may perform a slice-aware RACH procedure with the base station 110 to establish the PDU session. The UE 120 may transmit, to the base station 110, a request to initiate a RACH procedure that uses the RACH resources and/or RACH parameters selected by the UE 120 based at least in part on the intended slice for the PDU session.

As described above in connection with FIG. 4, the base station 110 may transmit, to the UE 120 in an RRC idle mode or an RRC inactive mode, a paging message that includes an indication identifying an intended slice for a PDU session associated with downlink (e.g., MT) traffic for the UE 120. The UE 120 may receive the paging message including the indication identifying the intended slice, and the UE 120 may select RACH resources and/or RACH parameters based at least in part on the intended slice. The UE 120 may transmit, to the base station 110, a request to initiate a slice-aware RACH procedure using the selected RACH resources and/or RACH parameters. As a result, the latency of the RACH procedure for the UE 120 may be reduced and the RACH procedure may be prioritized based on an application, application type, traffic type, or use case associated with the intended slice.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with signaling to indicate intended slice information in paging.

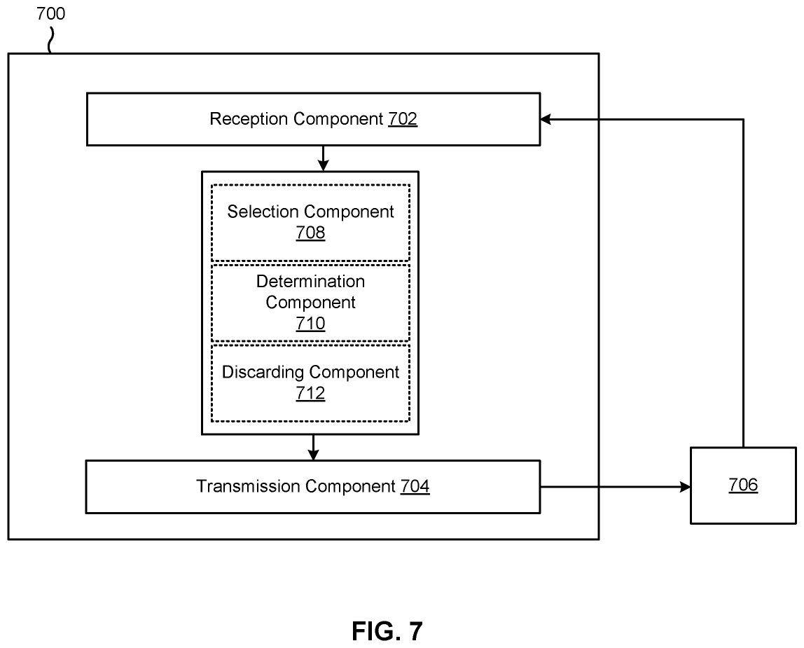

As shown in FIG. 5, in some aspects, process 500 may include receiving, in an RRC idle mode or an RRC inactive mode, a paging message that includes an indication identifying an intended slice for a PDU session associated with downlink traffic for the UE (block 510). For example, the UE (e.g., using reception component 702, depicted in FIG. 7) may receive, in an RRC idle mode or an RRC inactive mode, a paging message that includes an indication identifying an intended slice for a PDU session associated with downlink traffic for the UE, as described above.

As further shown in FIG. 5, in some aspects, process 500 may include transmitting, to a base station, a request to initiate a RACH procedure based at least in part on the intended slice (block 520). For example, the UE (e.g., using transmission component 704, depicted in FIG. 7) may transmit, to a base station, a request to initiate a RACH procedure based at least in part on the intended slice, as described above.

Process 500 may include additional aspects, such as any single aspect or any combination of aspects described below and/or in connection with one or more other processes described elsewhere herein.

In a first aspect, the indication includes an SST value associated with the intended slice.

In a second aspect, alone or in combination with the first aspect, the indication includes a slice group index associated with the intended slice.

In a third aspect, alone or in combination with one or more of the first and second aspects, process 500 includes receiving, prior to receiving the paging message, a configuration of a respective slice group index, for each of one or more allowed slices for the UE.

In a fourth aspect, alone or in combination with one or more of the first through third aspects, the indication is an urgent slice indication in a paging record of the paging message.

In a fifth aspect, alone or in combination with one or more of the first through fourth aspects, process 500 includes selecting, for the RACH procedure, one or more RACH resources associated with an urgent slice.

In a sixth aspect, alone or in combination with one or more of the first through fifth aspects, process 500 includes selecting, for the RACH procedure, one or more RACH parameters associated with an urgent slice.

In a seventh aspect, alone or in combination with one or more of the first through sixth aspects, the indication includes a PDU session identifier associated with the PDU session, and process 500 includes determining S-NSSAI for the intended slice based at least in part on the PDU session identifier.

In an eighth aspect, alone or in combination with one or more of the first through seventh aspects, the indication includes a radio bearer identifier for a logical channel associated with the intended slice.

In a ninth aspect, alone or in combination with one or more of the first through eighth aspects, the indication includes a cause value in a page record of the paging message, and process 500 includes determining the intended slice from the cause value based at least in part on a mapping between NSSAI and cause values.

In a tenth aspect, alone or in combination with one or more of the first through ninth aspects, process 500 includes receiving the mapping in an SIB.

In an eleventh aspect, alone or in combination with one or more of the first through tenth aspects, process 500 includes discarding the mapping, and receiving a new mapping in an SIB of the new cell.

In a twelfth aspect, alone or in combination with one or more of the first through eleventh aspects, process 500 includes receiving the mapping in an NAS message.

In a thirteenth aspect, alone or in combination with one or more of the first through twelfth aspects, the mapping is updated during at least one of a TAU procedure or an RNAU procedure.

In a fourteenth aspect, alone or in combination with one or more of the first through thirteenth aspects, process 500 includes receiving the mapping in an RRC release message.

In a fifteenth aspect, alone or in combination with one or more of the first through fourteenth aspects, the mapping is configured in the UE via subscription information associated network slicing.

In a sixteenth aspect, alone or in combination with one or more of the first through fifteenth aspects, process 500 includes selecting, for the RACH procedure, at least one of a RACH resource associated with the intended slice or a RACH parameter associated with the intended slice.

In a seventeenth aspect, alone or in combination with one or more of the first through sixteenth aspects, process 500 includes selecting, for the RACH procedure, one or more RACH resources from a RACH resource pool configured for the intended slice.

In an eighteenth aspect, alone or in combination with one or more of the first through seventeenth aspects, process 500 includes selecting, for the RACH procedure, one or more RACH resources from a RACH resource pool configured for a slice group associated with the intended slice.

In a nineteenth aspect, alone or in combination with one or more of the first through eighteenth aspects, process 500 includes selecting, for the RACH procedure, one or more RACH parameters associated with a prioritization level configured for the intended slice.

In a twentieth aspect, alone or in combination with one or more of the first through nineteenth aspects, process 500 includes selecting, for the RACH procedure, one or more RACH parameters associated with a prioritization level configured for a slice group associated with the intended slice.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with signaling to indicate intended slice information in paging.

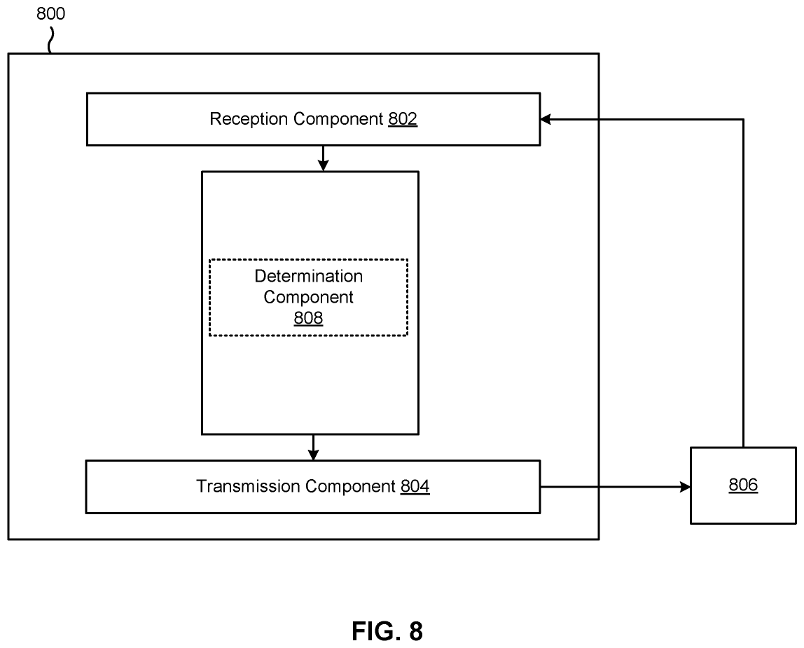

As shown in FIG. 6, in some aspects, process 600 may include transmitting, to a UE in an RRC idle mode or an RRC inactive mode, a paging message that includes an indication identifying an intended slice for a PDU session associated with downlink traffic for the UE (block 610). For example, the base station (e.g., using transmission component 804, depicted in FIG. 8) may transmit, to a UE in an RRC idle mode or an RRC inactive mode, a paging message that includes an indication identifying an intended slice for a PDU session associated with downlink traffic for the UE, as described above.

As further shown in FIG. 6, in some aspects, process 600 may include receiving, from the UE, a request to initiate a RACH procedure based at least in part on the intended slice (block 620). For example, the base station (e.g., using reception component 802, depicted in FIG. 8) may receive, from the UE, a request to initiate a RACH procedure based at least in part on the intended slice, as described above.

Process 600 may include additional aspects, such as any single aspect or any combination of aspects described below and/or in connection with one or more other processes described elsewhere herein.

In a first aspect, the indication includes an SST value associated with the intended slice.

In a second aspect, alone or in combination with the first aspect, the indication includes a slice group index associated with the intended slice.

In a third aspect, alone or in combination with one or more of the first and second aspects, the indication is an urgent slice indication in a paging record of the paging message.

In a fourth aspect, alone or in combination with one or more of the first through third aspects, the indication includes a PDU session identifier associated with the PDU session.

In a fifth aspect, alone or in combination with one or more of the first through fourth aspects, the indication includes a radio bearer identifier for a logical channel associated with the intended slice, and process 600 includes determining the radio bearer identifier for the logical channel associated with the intended slice based at least in part on N3 tunnel information for the downlink traffic.

In a sixth aspect, alone or in combination with one or more of the first through fifth aspects, the indication includes a cause value in a page record of the paging message, the cause value maps to the intended slice, and process 600 includes determining the cause value that maps to the intended slice based at least in part on a mapping between NSSAI and cause values.

In a seventh aspect, alone or in combination with one or more of the first through sixth aspects, process 600 includes transmitting the mapping to the UE in an SIB.

In an eighth aspect, alone or in combination with one or more of the first through seventh aspects, process 600 includes transmitting the mapping to the UE in an RRC release message.

In a ninth aspect, alone or in combination with one or more of the first through eighth aspects, receiving the request to initiate the RACH procedure comprises receiving, from the UE, the request to initiate the RACH procedure using one or more RACH resources associated with the intended slice.

In a tenth aspect, alone or in combination with one or more of the first through ninth aspects, receiving the request to initiate the RACH procedure comprises receiving, from the UE, the request to initiate the RACH procedure using one or more RACH parameters associated with the intended slice.

In an eleventh aspect, alone or in combination with one or more of the first through tenth aspects, process 600 includes receiving, from a core network device, slice information associated with the intended slice.

In a twelfth aspect, alone or in combination with one or more of the first through eleventh aspects, receiving the slice information associated with the intended slice includes receiving, from the core network device, an N2 paging request that includes the slice information associated with the intended slice.

In a thirteenth aspect, alone or in combination with one or more of the first through twelfth aspects, process 600 includes transmitting, to one or more other base stations in an RNA associated with the UE, a RAN paging message that includes the slice information associated with the intended slice.

In a fourteenth aspect, alone or in combination with one or more of the first through tenth aspects, process 600 includes receiving, from another base station in an RNA area associated with the UE, a RAN paging message that includes slice information associated with the intended slice.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include one or more of a selection component 708, a determination component 710, or a discarding component 712, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The reception component 702 may receive, in an RRC idle mode or an RRC inactive mode, a paging message that includes an indication identifying an intended slice for a PDU session associated with downlink traffic for the UE. The transmission component 704 may transmit, to a base station, a request to initiate a RACH procedure based at least in part on the intended slice.

The reception component 702 may receive, prior to receiving the paging message, a configuration of a respective slice group index, for each of one or more allowed slices for the UE.

The selection component 708 may select, for the RACH procedure, one or more RACH resources associated with an urgent slice.

The selection component 708 may select, for the RACH procedure, one or more RACH parameters associated with an urgent slice.

The determination component 710 may determine S-NSSAI for the intended slice based at least in part on a PDU session identifier.

The determination component 710 may determine the intended slice from the cause value based at least in part on a mapping between NSSAI and cause values.

The reception component 702 may receive the mapping in an SIB.

The discarding component 712 may discard the mapping.

The reception component 702 may receive a new mapping in an SIB of the new cell.

The reception component 702 may receive the mapping in an NAS message.

The reception component 702 may receive the mapping in an RRC release message.

The selection component 708 may select, for the RACH procedure, at least one of a RACH resource associated with the intended slice or a RACH parameter associated with the intended slice.

The selection component 708 may select, for the RACH procedure, one or more RACH resources from a RACH resource pool configured for the intended slice.

The selection component 708 may select, for the RACH procedure, one or more RACH resources from a RACH resource pool configured for a slice group associated with the intended slice.

The selection component 708 may select, for the RACH procedure, one or more RACH parameters associated with a prioritization level configured for the intended slice.

The selection component 708 may select, for the RACH procedure, one or more RACH parameters associated with a prioritization level configured for a slice group associated with the intended slice.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a block diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a determination component 808, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the base station described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a demodulator, a MIMO detector, a receive processor, a controller/processor, a memory, or a combination thereof, of the base station described above in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the base station described above in connection with FIG. 2. In some aspects, the transmission component 804 may be co-located with the reception component 802 in a transceiver.

The transmission component 804 may transmit, to a UE in an RRC idle mode or an RRC inactive mode, a paging message that includes an indication identifying an intended slice for a PDU session associated with downlink traffic for the UE. The reception component 802 may receive, from the UE, a request to initiate a RACH procedure based at least in part on the intended slice.

The determination component 808 may determine a radio bearer identifier for the logical channel associated with the intended slice based at least in part on N3 tunnel information for the downlink traffic.

The determination component 808 may determine a cause value that maps to the intended slice based at least in part on a mapping between NSSAI and cause values.

The transmission component 804 may transmit the mapping to the UE in an SIB.

The transmission component 804 may transmit the mapping to the UE in an RRC release message.

The reception component 802 may receive, from a core network device, slice information associated with the intended slice.

The transmission component 804 may transmit, to one or more other base stations in an RNA associated with the UE, a RAN paging message that includes the slice information associated with the intended slice.

The reception component 802 may receive, from another base station in an RNA associated with the UE, a RAN paging message that includes slice information associated with the intended slice.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, in a radio resource control (RRC) idle mode or an RRC inactive mode, a paging message that includes an indication identifying an intended slice for a protocol data unit (PDU) session associated with downlink traffic for the UE; and transmitting, to a base station, a request to initiate a random access channel (RACH) procedure based at least in part on the intended slice.

Aspect 2: The method of Aspect 1, wherein the indication includes a slice/service type (SST) value associated with the intended slice.

Aspect 3: The method of any of Aspects 1-2, wherein the indication includes a slice group index associated with the intended slice.

Aspect 4: The method of Aspect 3, further comprising: receiving, prior to receiving the paging message, a configuration of a respective slice group index, for each of one or more allowed slices for the UE.

Aspect 5: The method of any of Aspects 1-4, wherein the indication is an urgent slice indication in a paging record of the paging message.

Aspect 6: The method of Aspect 5, further comprising: selecting, for the RACH procedure, one or more RACH resources associated with an urgent slice.

Aspect 7: The method of any of Aspects 5-6, further comprising: selecting, for the RACH procedure, one or more RACH parameters associated with an urgent slice.

Aspect 8: The method of any of Aspects 1-7, wherein the indication includes a PDU session identifier associated with the PDU session, and further comprising: determining single-network slice selection assistance information (S-NSSAI) for the intended slice based at least in part on the PDU session identifier.

Aspect 9: The method of any of Aspects 1-8, wherein the indication includes a radio bearer identifier for a logical channel associated with the intended slice.

Aspect 10: The method of any of Aspects 1-9, wherein the indication includes a cause value in a page record of the paging message, and further comprising: determining the intended slice from the cause value based at least in part on a mapping between network slice selection assistance information (NSSAI) and cause values.

Aspect 11: The method of Aspect 10, further comprising: receiving the mapping in a system information block (SIB).

Aspect 12: The method of Aspect 11, further comprising, based at least in part on the UE performing cell reselection in which the UE switches to a new cell: discarding the mapping; and receiving a new mapping in an SIB of the new cell.

Aspect 13: The method of any of Aspects 10-12, further comprising: receiving the mapping in a non-access stratum (NAS) message.

Aspect 14: The method of Aspect 13, wherein the mapping is updated during at least one of a tracking area update (TAU) procedure or a radio access network (RAN) area update (RNAU) procedure.

Aspect 15: The method of any of Aspects 10-14, further comprising: receiving the mapping in an RRC release message.

Aspect 16: The method of any of Aspects 10-15, wherein the mapping is configured in the UE via subscription information associated network slicing.

Aspect 17: The method of any of Aspects 1-16, further comprising: selecting, for the RACH procedure, at least one of a RACH resource associated with the intended slice or a RACH parameter associated with the intended slice.

Aspect 18: The method of any of Aspects 1-17, further comprising: selecting, for the RACH procedure, one or more RACH resources from a RACH resource pool configured for the intended slice.

Aspect 19: The method of any of Aspects 1-17, further comprising: selecting, for the RACH procedure, one or more RACH resources from a RACH resource pool configured for a slice group associated with the intended slice.

Aspect 20: The method of any of Aspects 1-19, further comprising: selecting, for the RACH procedure, one or more RACH parameters associated with a prioritization level configured for the intended slice.

Aspect 21: The method of any of Aspects 1-19, further comprising: selecting, for the RACH procedure, one or more RACH parameters associated with a prioritization level configured for a slice group associated with the intended slice.

Aspect 22: A method of wireless communication performed by a base station, comprising: transmitting, to a user equipment (UE) in a radio resource control (RRC) idle mode or an RRC inactive mode, a paging message that includes an indication identifying an intended slice for a protocol data unit (PDU) session associated with downlink traffic for the UE; and receiving, from the UE, a request to initiate a random access channel (RACH) procedure based at least in part on the intended slice.

Aspect 23: The method of Aspect 22, wherein the indication includes a slice/service type (SST) value associated with the intended slice.

Aspect 24: The method of any of Aspects 22-23, wherein the indication includes a slice group index associated with the intended slice.

Aspect 25: The method of any of Aspects 22-24, wherein the indication is an urgent slice indication in a paging record of the paging message.

Aspect 26: The method of any of Aspects 22-5, wherein the indication includes a PDU session identifier associated with the PDU session.

Aspect 27: The method of any of Aspects 22-26, wherein the indication includes a radio bearer identifier for a logical channel associated with the intended slice, and further comprising: determining the radio bearer identifier for the logical channel associated with the intended slice based at least in part on N3 tunnel information for the downlink traffic.

Aspect 28: The method of any of Aspects 22-27, wherein the indication includes a cause value in a page record of the paging message, wherein the cause value maps to the intended slice, and further comprising: determining the cause value that maps to the intended slice based at least in part on a mapping between network slice selection assistance information (NSSAI) and cause values.

Aspect 29: The method of Aspect 28, further comprising: transmitting the mapping to the UE in a system information block (SIB).

Aspect 30: The method of any of Aspects 28-29, further comprising: transmitting the mapping to the UE in an RRC release message.

Aspect 31: The method of any of Aspects 22-30, wherein receiving the request to initiate the RACH procedure comprises: receiving, from the UE, the request to initiate the RACH procedure using one or more RACH resources associated with the intended slice.

Aspect 32: The method of any of Aspects 22-31, wherein receiving the request to initiate the RACH procedure comprises: receiving, from the UE, the request to initiate the RACH procedure using one or more RACH parameters associated with the intended slice.

Aspect 33: The method of any of Aspects 22-32, further comprising: receiving, from a core network device, slice information associated with the intended slice.

Aspect 34: The method of Aspect 33, wherein receiving the slice information associated with the intended slice comprises: receiving, from the core network device, an N2 paging request that includes the slice information associated with the intended slice.

Aspect 35: The method of any of Aspects 33-34, further comprising: transmitting, to one or more other base stations in a radio access network (RAN) based notification area associated with the UE, a RAN paging message that includes the slice information associated with the intended slice.

Aspect 36: The method of any of Aspects 22-32, further comprising: receiving, from another base station in a radio access network (RAN) based notification area associated with the UE, a RAN paging message that includes slice information associated with the intended slice.

Aspect 37: An apparatus for wireless communication at a device, comprising a processor; memory coupled with the processor; and instructions stored in the memory and executable by the processor to cause the apparatus to perform the method of one or more Aspects of Aspects 1-21.

Aspect 38: An apparatus for wireless communication at a device, comprising a processor; memory coupled with the processor; and instructions stored in the memory and executable by the processor to cause the apparatus to perform the method of one or more Aspects of Aspects 22-36.

Aspect 39: A device for wireless communication, comprising a memory and one or more processors coupled to the memory, the memory and the one or more processors configured to perform the method of one or more Aspects of Aspects 1-21.

Aspect 40: A device for wireless communication, comprising a memory and one or more processors coupled to the memory, the memory and the one or more processors configured to perform the method of one or more Aspects of Aspects 22-36.

Aspect 41: An apparatus for wireless communication, comprising at least one means for performing the method of one or more Aspects of Aspects 1-21.

Aspect 42: An apparatus for wireless communication, comprising at least one means for performing the method of one or more Aspects of Aspects 22-36.

Aspect 43: A non-transitory computer-readable medium storing code for wireless communication, the code comprising instructions executable by a processor to perform the method of one or more Aspects of Aspects 1-21.

Aspect 44: A non-transitory computer-readable medium storing code for wireless communication, the code comprising instructions executable by a processor to perform the method of one or more Aspects of Aspects 22-36.

Aspect 45: A non-transitory computer-readable medium storing a set of instructions for wireless communication, the set of instructions comprising one or more instructions that, when executed by one or more processors of a device, cause the device to perform the method of one or more Aspects of Aspects 1-21.

Aspect 46: A non-transitory computer-readable medium storing a set of instructions for wireless communication, the set of instructions comprising one or more instructions that, when executed by one or more processors of a device, cause the device to perform the method of one or more Aspects of Aspects 22-36.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving, in a radio resource control (RRC) idle mode or an RRC inactive mode, a paging message that includes an indication identifying an intended slice for a protocol data unit (PDU) session associated with downlink traffic for the UE; and
transmitting, to a base station, a request to initiate a random access channel (RACH) procedure based at least in part on the intended slice.

2. The method of claim 1, wherein the indication includes a slice/service type (SST) value associated with the intended slice.

3. The method of claim 1, wherein the indication includes a slice group index associated with the intended slice, and further comprising:
receiving, prior to receiving the paging message, a configuration of a respective slice group index, for each of one or more allowed slices for the UE.

4. (canceled)

5. The method of claim 1, wherein the indication is an urgent slice indication in a paging record of the paging message, and further comprising:
selecting, for the RACH procedure, one or more RACH resources associated with an urgent slice or one or more RACH parameters associated with an urgent slice.

6-7. (canceled)

8. The method of claim 1, wherein the indication includes a PDU session identifier associated with the PDU session, and further comprising:
determining single-network slice selection assistance information (S-NSSAI) for the intended slice based at least in part on the PDU session identifier.

9. The method of claim 1, wherein the indication includes a radio bearer identifier for a logical channel associated with the intended slice.

10. The method of claim 1, wherein the indication includes a cause value in a page record of the paging message, and further comprising:
determining the intended slice from the cause value based at least in part on a mapping between network slice selection assistance information (NSSAI) and cause values.

11. The method of claim 10, further comprising:
receiving the mapping in a system information block (SIB).

12. The method of claim II, further comprising, based at least in part on the UE performing cell reselection in which the UE switches to a new cell:
discarding the mapping; and
receiving a new mapping in an SIB of the new cell.

13. The method of claim 7, further comprising:
receiving the mapping in a non-access stratum (NAS) message.

14. The method of claim 13, wherein the mapping is updated during at least one of a tracking area update (TAU) procedure or a radio access network (RAN) area update (RNAU) procedure.

15. The method of claim 7, further comprising:
receiving the mapping in an RRC release message.

16. The method of claim 7, wherein the mapping is configured in the UE via subscription information associated network slicing.

17. The method of claim 1, further comprising:
selecting, for the RACH procedure, at least one of a RACH resource associated with
the intended slice or a RACH parameter associated with the intended slice.

18. The method of claim 1, further comprising:
selecting, for the RACH procedure, one or more RACH resources from a RACH resource pool configured for the intended slice, or a slice group associated with the intended slice; or
selecting, for the RACH procedure, one or more RACH parameters associated with a prioritization level configured for the intended slice or a slice group associated with the intended slice.

19-21. (canceled)

22. A method of wireless communication performed by a base station, comprising:
transmitting, to a user equipment (UE) in a radio resource control (RRC) idle mode or an RRC inactive mode, a paging message that includes an indication identifying an intended slice for a protocol data unit (PDU) session associated with downlink traffic for the UE; and
receiving, from the UE, a request to initiate a random access channel (RACH) procedure based at least in part on the intended slice.

23. The method of claim 22, wherein the indication includes a slice/service type (SST) value associated with the intended slice, the indication includes a slice group index associated with the intended slice, the indication is an urgent slice indication in a paging record of the paging message, or the indication includes a PDU session identifier associated with the PDU session.

24-26. (canceled)

27. The method of claim 22, wherein the indication includes a radio bearer identifier for a logical channel associated with the intended slice, and further comprising:
determining the radio bearer identifier for the logical channel associated with the intended slice based at least in part on N3 tunnel information for the downlink traffic.

28. The method of claim 22, wherein the indication includes a cause value in a page record of the paging message, wherein the cause value maps to the intended slice, and further comprising:
determining the cause value that maps to the intended slice based at least in part on a mapping between network slice selection assistance information (NSSAI) and cause values.

29. The method of claim 28, further comprising:
transmitting the mapping to the UE in a system information block (SIB) or an RRC release message.

30. (canceled)

31. The method of claim 22, wherein receiving the request to initiate the RACH procedure comprises:
receiving, from the UE, the request to initiate the RACH procedure using one or more EACH resources associated with the intended slice or one or more RACH parameters associated with the intended slice.

32. (canceled)

33. The method of claim 22, further comprising:
receiving, from a core network device, slice information associated with the intended slice.

34. The method of claim 33, wherein receiving the slice information associated with the intended slice comprises:
receiving, from the core network device, an N2 paging request that includes the slice information associated with the intended slice.

35. The method of claim 33, further comprising:
transmitting, to one or more other base stations in a radio access network (RAN) based notification area associated with the UE, a RAN paging message that includes the slice information associated with the intended slice.

36. The method of claim 22, further comprising:
receiving, from another base station in a radio access network (RAN) based notification area associated with the UE, a RAN paging message that includes slice information associated with the intended slice.

37. A user equipment (UE) for wireless communication, comprising:
a memory; and
one or more processors operatively coupled to the memory, the memory and the one or more processors configured to:
receive, in a radio resource control (RRC) idle mode or an RRC inactive mode, a paging message that includes an indication identifying an intended slice for a protocol data unit (PDU) session associated with downlink traffic for the UE; and
transmit, to a base station, a request to initiate a random access channel (RACH) procedure based at least in part on the intended slice.

38. The UE of claim 37, wherein the indication includes a slice/service type (SST) value associated with the intended slice, the indication includes a slice group index associated with the intended slice, the indication is an urgent slice indication in a paging record of the paging message, the indication includes a PDU session identifier associated with the PDU session, or the indication includes a radio bearer identifier for a logical channel associated with the intended slice.

39-45. (canceled)

46. The UE of claim 37, wherein the indication includes a cause value in a page record of the paging message, and the one or more processors are further configured to:
determine the intended slice from the cause value based at least in part on a mapping between network slice selection assistance information (NSSAI) and cause values.

47-52. (canceled)

53. A base station for wireless communication, comprising:
a memory; and
one or more processors operatively coupled to the memory, the memory and the one or more processors configured to:
transmit, to a user equipment (UE) in a radio resource control (RRC) idle mode or an RRC inactive mode, a paging message that includes an indication identifying an intended slice for a protocol data unit (PDU) session associated with downlink traffic for the UE; and
receive, from the UE, a request to initiate a random access channel (RACH) procedure based at least in part on the intended slice.

54-112. (canceled)
